(19) United States
(12) Patent Application Publication
(10) Pub. No.: US 2026/0138380 A1
(43) Pub. Date: May 21, 2026

(54) DRYING DEVICE AND PRINTING APPARATUS

(71) Applicant: SCREEN Holdings Co., Ltd., Kyoto (JP)

(72) Inventors: Daiki MATSUKAWA, Kyoto-shi (JP); Yuki TSUTSUI, Kyoto-shi (JP); Junichi SHIMIZU, Kyoto-shi (JP); Takahiro UDA, Kyoto-shi (JP); Mitsuru TANEMOTO, Kyoto-shi (JP)

(21) Appl. No.: 19/386,380

(22) Filed: Nov. 12, 2025

(30) Foreign Application Priority Data
Nov. 20, 2024 (JP) 2024-202648

(51) Int. Cl. B41J 11/00; B41J 15/04

(52) U.S. Cl. CPC B41J 11/00212; B41J 11/00216; B41J 11/00218; B41J 11/0022; B41J 15/048

(57) ABSTRACT

A drying device performs a first mode where a quantity of the output light is large and a shielding ratio is low and a second mode where the quantity of the output light is relatively small and the shielding ratio is high. It is possible to provide compatibility between the first mode and the second mode by changing a way of incidence in which the light enters the current cutoff unit and generating a difference between the first mode and the second mode in a sensitivity characteristic indicating a correlation between the quantity of the light and a temperature of a current cutoff element. In a drying device and a printing apparatus for drying a print medium by heating after the print medium is printed, it is possible to provide a protective function to work effectively even in the presence of two modes of different quantities of heat.

### CROSS REFERENCE TO RELATED APPLICATION

The disclosure of Japanese Patent Application No. 2024-202648 filed on Nov. 20, 2024 including specification, drawings and claims is incorporated herein by reference in its entirety.

### BACKGROUND OF THE INVENTION

### 1. Field of the Invention

The present invention relates to a drying device for drying a print medium by heat after the print medium is printed, and a printing apparatus including the drying device.

### 2. Description of the Related Art

Regarding a printing technique of performing printing on a print medium using a recording material such as ink, it is required to promptly dry the print medium with the attached recording material. In response to this, a printing apparatus or a printing system to perform such printing is provided with a drying device for drying the print medium by heating. As an example, according to a printing apparatus shown by JP2022-138461A (Patent Literature 1) disclosed previously by the applicant of the present application, in response to changeability of a transport speed of web paper as a print medium, it is possible to implement a mode of applying heat of a large quantity and a mode of applying heat of a smaller quantity to the print medium.

According to this technique, a shutter capable of being opened and closed is provided between a light source to emit light including infrared rays and the print medium. Increasing the quantity of light from the light source and placing the shutter in an open state allows high-intensity light from the light source to enter a surface of the print medium directly, making it possible to apply heat of a large quantity in a short time to the print medium. On the other hand, reducing the quantity of light output from the light source and placing the shutter in a closed state allows the print medium to be heated gently via warmed air instead of causing light to enter the print medium directly.

Such a printing apparatus is certainly provided with control means for properly controlling the quantity of light output from the light source in response to a purpose. Additionally, it is desirably provided with a protective mechanism for preventing the quantity of generated light from becoming excessively large even on the occurrence of trouble in the control. In one configuration, a current cutoff element is interposed in a current path to the light source and the current path is cut off on the occurrence of temperature increase beyond the scope of assumption, for example.

A thermostat is preferably available as such a current cutoff element, for example. The thermostat has the action of cutting off a current path forcedly if a cutoff temperature unique to the element is exceeded, namely, cutting off the current path autonomously by the element itself independently of control. Thus, the thermostat is expected to be an effective countermeasure against such abnormality.

However, the above configuration having the two modes of different quantities of light output from the light source has a problem to be considered in terms of a way of using the current cutoff element. Specifically, if the arrangement and cutoff temperature of the current cutoff element are set in such a manner that the protective mechanism works effectively even in the mode of a small quantity of output light, for example, the current cutoff element might work more than necessary in the other mode of a large quantity of output light to cause greater temperature increase. Conversely, making the setting responsive to the other mode of a large quantity of output light might cause a problem that the current cutoff element does not work properly in the mode of a small quantity of output light. Among these issues, a problem to be particularly considered is that the protective function does not work when needed.

Patent Literature 1 makes no mention about a protective function on the occurrence of such abnormality, so that it provides no statement about installation of a current cutoff element responsive to two modes such as those described above. As seen from the above, in relation to the printing apparatus having the two modes of different quantities of light output from the light source and the drying device for the printing apparatus, there arises a need to establish a technique allowing the protective function to work effectively while providing compatibility between these modes to.

### SUMMARY OF THE INVENTION

The present invention has been made in view of the above problem. In a drying device and a printing apparatus for drying a print medium by heating after the print medium is printed, the present application is intended to provide a protective function to work effectively even in the presence of two modes of different quantities of heat.

One aspect of the present application is intended for a drying device for drying a print medium after the print medium is printed, comprising: a light source configured to emit light toward the print medium in response to feed of a current; a current cutoff unit including a current cutoff element configured to cut off the current to be fed to the light source if being increased to a higher temperature than a predetermined cutoff temperature; a sensitivity changing unit configured to change a sensitivity characteristic which indicates a correlation between a quantity of the light output from the light source and a degree of temperature increase at the current cutoff element by changing a way of incidence in which the light from the light source enters the current cutoff unit; a light shield located between the light source and the print medium and which changes a shielding ratio of shielding the light from the light source toward the print medium; and a controller configured to selectively implement a first mode and a second mode differing from each other in the quantity of the output light and the shielding ratio.

The quantity of the output light is larger and the shielding ratio is smaller in the first mode than in the second mode. The sensitivity changing unit makes a temperature of the current cutoff element less than the cutoff temperature in each of the first mode and the second mode by generating a difference in the sensitivity characteristic between the first mode and the second mode.

According to the application having the above configuration, implementing the first mode causes the light emitted from the light source to enter the print medium directly, making it possible to facilitate rapid drying of the print medium with radiant heat of a high heat quantity. On the other hand, in the second mode, the quantity of the light output from the light source is smaller and the ratio of shielding the light is higher. Thus, the quantity of heat applied to the print medium is smaller than that in the first mode.

As described above, it is required to provide a protective mechanism capable of avoiding abnormal temperature increase due to an excessive current, for example, while providing compatibility between the first mode where temperature increase is large and the second mode where temperature increase is smaller. According to the present application, protection against excessive heating is realized using the current cutoff element configured to forcedly cut off feed of the current to the light source if the current cutoff element is increased to the predetermined cutoff temperature.

More specifically, the sensitivity changing unit changes the sensitivity characteristic of the current cutoff element to the quantity of the light output from the light source, that is, changes the correlation between the quantity of the light output from the light source and a degree of temperature increase at the current cutoff element by changing a way of incidence in which the light enters the current cutoff unit. Further, different sensitivity characteristics are employed in the first mode and the second mode. Thus, even if the quantities of the light output from the light source are equal between the first mode and the second mode, temperatures at the current cutoff element to be increased by the light of these quantities do not become equal between the first mode and the second mode.

By taking advantage of this point, preventing a temperature of the current cutoff element from reaching the cutoff temperature in the absence of abnormality in operation in each of the first mode and the second mode avoids a problem that the protective function works more than necessary in either mode. On the other hand, on the occurrence of excessive heating in either mode, a temperature at the current cutoff element is increased further. If the temperature finally reaches the cutoff temperature, a current to be fed to the light source is cut off forcedly. By doing so, emission of the light from the light source is stopped to avoid abnormal temperature increase.

In this way, in each of the first mode and the second mode of different quantities of heat generation from the light source, it is possible to suppress superfluous intervention of the protective function during normal operation and also possible to make the protection work appropriately in response to excessive temperature increase.

Another aspect of the present application is intended for a printing apparatus comprising: a transport unit configured to transport a print medium; a printing unit configured to perform printing on the print medium being transported; and a drying device provided downstream from the printing unit along a transportation path of the print medium and having the same configuration as the drying device described above. According to the application having the above configuration, the drying device configured to dry the print medium after the print medium is printed achieves the excellent effect described above. Thus, it is possible to dry the print medium favorably while avoiding trouble due to abnormal heating.

As described above, according to the present application, by generating a difference in the sensitivity characteristic in terms of temperature increase to the quantity of light output from the light source between the two modes of different quantities of heat generation from the light source, it becomes possible to provide a protective function capable of avoiding abnormal temperature increase while preventing the protective function from working more than necessary.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a schematic configuration view showing the printing apparatus entirely according to the present application.

FIG. 2 shows a drying mechanism provided to the printing apparatus.

FIG. 3 shows a principal part of the drying mechanism.

FIGS. 4A to 4C show an internal configuration of the heating unit.

FIGS. 5A and 5B show two modes implemented by the drying mechanism.

FIGS. 6A and 6B are block diagrams showing the configuration of the controller relating to control over the drying mechanism.

FIGS. 7A to 7C show the idea of the protective mechanism using the thermostat.

FIG. 8 shows a relationship between the open-closed state of the shutter and a temperature distribution.

FIG. 9 shows a case where there is no overlap between the preferred regions in the two modes.

FIGS. 10A and 10B show a state where the thermostat is mounted on the movable plate.

FIG. 11 shows a mechanism for interlocking the movable plates.

FIGS. 12A and 12B show an example where the movable plate is used as a light-shielding plate for the thermostat unit.

FIGS. 13A and 13B show another modification.

FIGS. 14A and 14B show other modifications.

### DETAILED DESCRIPTION OF THE PREFERRED EMBODIMENTS

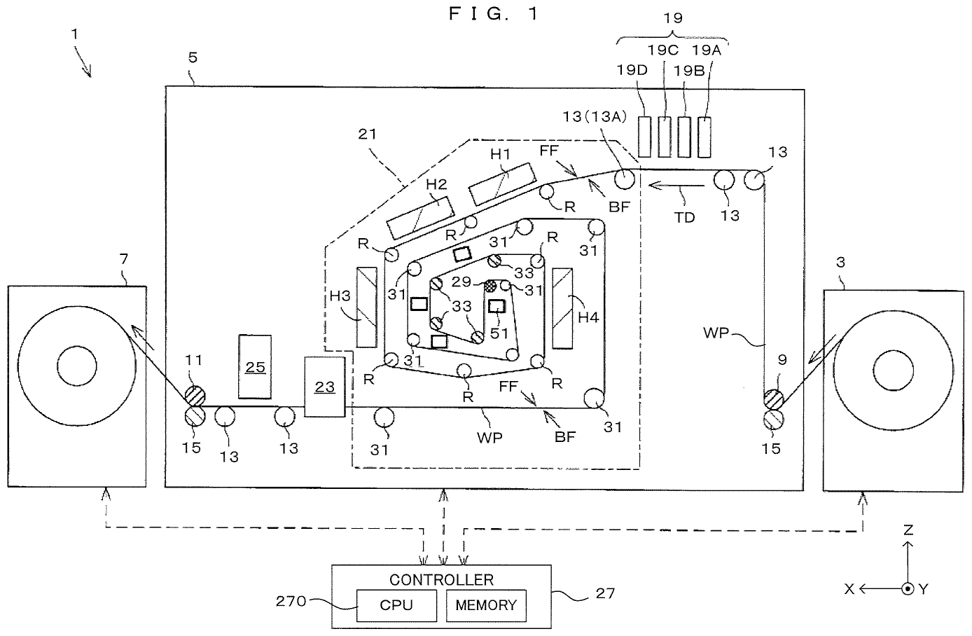

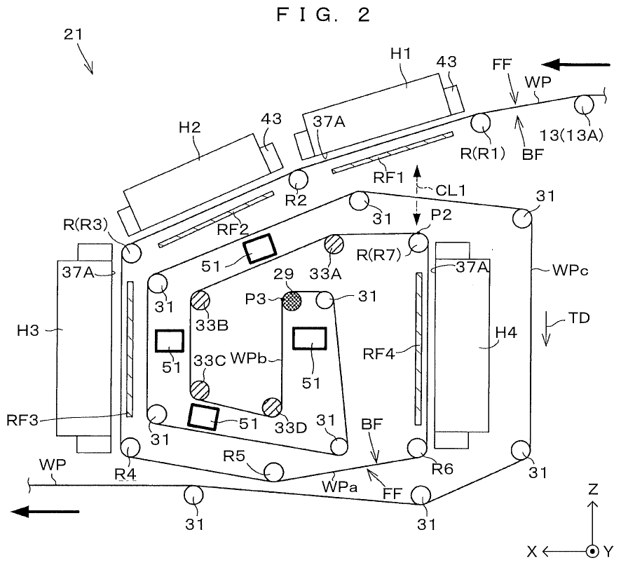

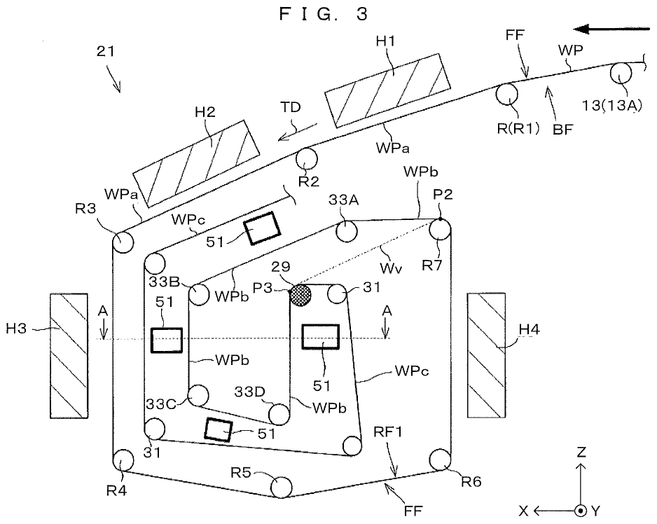

One embodiment of a printing apparatus according to the present invention will be described below by referring to the drawings. FIG. 1 is a schematic configuration view showing the printing apparatus entirely according to the present application. FIG. 2 shows a drying mechanism provided to the printing apparatus. FIG. 3 shows a principal part of the drying mechanism.

### Description of Entire Configuration

The entire configuration of a printing apparatus 1 will be described first by referring to FIG. 1. The printing apparatus 1 of the present embodiment is an inkjet printing apparatus. The printing apparatus 1 includes a paper feeder 3, a printing apparatus main body 5, and a paper ejector 7. In order to show directions in a unified manner in each of the drawings referred to below, XYZ orthogonal coordinates are defined as shown in FIG. 1. Here, an XY plane represents a horizontal plane and a Z direction represents a vertical direction. More specifically, a (−Z) direction represents a vertically-downward direction. FIG. 1 is a front view of the printing apparatus 1. A near side of the plane of the drawing, namely, a (+Y) side corresponds to the front of the printing apparatus 1.

The paper feeder 3 holds a roll of web paper (continuous paper) WP rotatably about a horizontal axis. The paper feeder 3 feeds the web paper WP from the roll of the web paper WP to the printing apparatus main body 5. The printing apparatus main body 5 performs printing on the elongated web paper WP. Then, the paper ejector 7 winds up the web paper WP about the horizontal axis after the web paper WP is printed by the printing apparatus main body 5. The paper ejector 7 includes an electric motor configured to wind up the web paper WP. With a side of feeding the web paper WP defined as an upstream side and a side of ejecting the web paper WP defined as a downstream side, the paper feeder 3 is located upstream from the printing apparatus main body 5.

The printing apparatus main body 5 includes a drive roller 9, a drive roller 11, a plurality of transport rollers 13, and a nip roller 15. The drive roller 9 is located adjacent to an inlet of the printing apparatus main body 5. The drive roller 11 is located adjacent to an outlet of the printing apparatus main body 5. Each of the drive roller 9 and the drive roller 11 is supported rotatably and driven by an electric motor. The drive roller 9 takes up the web paper WP from the paper feeder 3. The drive roller 11 feeds out the web paper WP to the paper ejector 7. Each of the drive roller 9 and the drive roller 11 applies power for transportation to the web paper WP. The transport rollers 13 are rollers supported rotatably and configured to guide the web paper WP, and are driven rollers to be driven to rotate by coming into contact with the moving web paper WP. Unlike the drive roller 11, the transport rollers 13 do not include an electric motor and do not apply power for transportation of the web paper WP.

The printing apparatus main body 5 further includes a printing unit 19, a drying mechanism 21, a cooling unit 23, and an inspecting unit 25 arranged in this order from the upstream side along a transportation path of the web paper WP.

The printing unit 19 attaches inks (ink droplets) to a printing face FF of the web paper WP being transported. The printing unit 19 includes four inkjet heads 19A to 19D, for example. The four inkjet heads 19A to 19D eject ink droplets by a piezoelectric element system or a thermal (bubble) system, for example. The most upstream inkjet head 19A ejects black (K) ink droplets. The next inkjet head 19B ejects cyan (C) ink droplets. The next inkjet head 19C ejects magenta (M) ink droplets. The next inkjet head 19D ejects yellow (Y) ink droplets.

While the printing unit 19 includes the four inkjet heads 19A to 19D in this example, it is not limited to this. The printing unit 19 may include one inkjet head, or two or six inkjet heads, for example. Further, the ink color order is not limited to this.

The drying mechanism 21 heats the web paper WP unloaded (transported) from the printing unit 19 to dry the inks. The detailed configuration of the drying mechanism 21 will be described later. The cooling unit 23 cools the web paper WP heated by the drying mechanism 21. The cooling unit 23 includes, for example, a water-cooled roller containing a flow path through which cooling water flows. The inspecting unit 25 includes a CCD sensor or a contact image sensor (CIS), for example. The inspecting unit 25 inspects images printed on the web paper WP.

The printing apparatus 1 includes a controller 27. The controller 27 controls the structures in the printing apparatus 1 (the printing unit 19 and the drying mechanism 21, for example). To achieve this, the controller 27 includes a memory storing a program necessary for the motion of the printing apparatus 1, and a central processing unit (CPU) 270 to execute the problem. A computer device having a general hardware construction which includes a CPU, a memory, a storage, an input/output device and the like is applicable as the controller 27.

### Configuration of Drying Mechanism

The configuration of the drying mechanism 21 forming a characteristic part of the present invention will be described next using FIGS. 2 and 3. FIG. 3 shows the transportation path of the web paper WP in the drying mechanism 21 in detail.

### (A) Configuration of Rollers

The drying mechanism 21 includes a guide roller R, a printing face contact roller 29, a transport roller 31, and a path changing roller 33. The transport roller and the printing face contact roller may simply be called “rollers,” if appropriate. The printing face FF of the web paper WP is a face with ink attached by the printing unit 19. A rear face BF of the web paper WP is a face opposite to the printing face FF and is a face with no ink attached by the printing unit 19.

Like the above-described transport rollers 13, the guide roller R, the printing face contact roller 29, the transport roller 31, and the path changing roller 33 are driven rollers. More specifically, each of the guide roller R, the printing face contact roller 29, the transport roller 31, and the path changing roller 33 is supported rotatably and configured to guide the web paper WP. As each of the guide roller R, the printing face contact roller 29, the transport roller 31, and the path changing roller 33 does not include an electric motor, it does not apply power for transportation of the web paper WP and is driven to rotate by coming into contact with the moving web paper WP.

In this embodiment, seven guide rollers R are provided. As shown in FIGS. 2 and 3, the guide rollers R are distinguished from each other by giving the guide rollers R respective signs R1 to R7 in order from the upstream side of a transportation direction of the web paper WP. Specifically, among the guide rollers R, the guide roller R1 is located on the most upstream side and the guide roller R7 is located on the most downstream side.

Each guide roller R comes into contact with the rear face BF of the web paper WP unloaded from the printing unit 19 to change the transportation direction of the web paper WP. The printing face contact roller 29 is located downstream from the seven guide rollers R1 to R7. Among the plurality of rollers belonging to the drying mechanism 21 (printing apparatus 1), the printing face contact roller 29 is a roller to come into contact with the printing face FF of the web paper WP first. The printing face contact roller 29 further has the function of changing the transportation direction of the web paper WP. After the web paper WP is unloaded from the printing unit 19 and loaded into the drying mechanism 21 via an inlet thereof, the web paper WP is transported in a swirling form by the guide rollers R1 to R7.

A path along which the web paper WP is transported by the guide rollers R1 to R7 is described here. First, the web paper WP unloaded from the printing unit 19 is transported by a transport roller 13A, the guide roller R1, the guide roller R2, and the guide roller R3 in this order. These transport roller 13A and guide rollers R1 to R3 are located downstream from the printing unit 19 and ahead of the printing unit 19 in the transportation direction in a plan view.

The transport roller 13A is located downstream from the printing unit 19 (specifically, the most downstream inkjet head 19D) and upstream from the guide roller R3. The transport roller 13A is located near the inkjet head 19D. The transport roller 13A comes into contact with the rear face BF of the web paper WP. Each of the transport roller 13A, the guide roller R1, and the guide roller R2 guides the web paper WP diagonally downward while placing the web paper WP in a posture of pointing the printing face FF upward. An inclination angle (absolute value) of the web paper WP increases toward the guide roller R3. After the web paper WP is turned in direction by the rollers 13A, R1, and R2, the web paper WP is turned by the guide roller R3 to a vertically downward direction.

After the web paper WP is transported to the guide roller R3, the web paper WP is transported to the guide rollers R4, R5, R6, and R7 in this order. After the web paper WP is turned in direction by the guide roller R3, the guide roller R4 turns the web paper WP to a diagonally downward direction while placing the web paper WP in a posture of pointing the printing face FF downward.

The guide roller R5 is located at a lower position than the guide roller R4. The guide roller R5 turns the web paper WP to a diagonally upward direction while placing the web paper WP in a posture of pointing the printing face FF downward.

The guide roller R6 is located at a higher position than the guide roller R5. The guide roller R6 is located at the substantially same height position as the guide roller R4. After the web paper WP is turned in direction by the guide roller R5, the guide roller R6 turns the web paper WP to a vertically upward direction.

The guide roller R7 is located at a higher position than the guide roller R6. The guide roller R7 is located at the substantially same height position as the guide roller R3. The guide roller R7 is located between the web paper WP transported between the transport roller 13A and the guide roller R3, and the guide roller R6. After the web paper WP is turned in direction by the guide roller R6, the guide roller R7 turns the web paper WP to a diagonally downward direction while placing the web paper WP in a posture of pointing the printing face FF upward.

As shown in FIG. 2, the four guide rollers R3, R4, R6, and R7 are located in a substantially rectangular pattern when viewed in a width direction orthogonal to a transportation direction TD of the web paper WP. The width direction of the web paper WP corresponds to the Y direction in FIG. 1 and others.

As shown in FIG. 2, the printing face contact roller 29 is located at a position surrounded by the four guide rollers R3, R4, R6, and R7. In other words, the printing face contact roller 29 is located at a position surrounded by the web paper WP transported from the guide roller R3 to the guide roller R7.

The printing face contact roller 29 is a roller to come into contact with the printing face FF of the web paper WP first after attachment of ink. The printing face contact roller 29 guides the web paper WP in a direction toward an outlet of the drying mechanism 21 by folding the web paper WP back after the ink thereon is dried. More specifically, the printing face contact roller 29 and the transport roller 31 are used for the guidance toward the outlet of the drying mechanism 21.

The transport roller 31 is located downstream from the printing face contact roller 29. In this embodiment, nine transport rollers 31 are provided at the drying mechanism 21. After the web paper WP is folded back by the printing face contact roller 29, the nine transport rollers 31 guide the web paper WP to the outlet of the drying mechanism 21 while passing the web paper WP through a clearance CL1 between the web paper WP transported between the transport roller 13A and the guide roller R3 and the web paper WP transported between the guide roller R7 and the printing face contact roller 29.

Regarding a section where the web paper WP is transported, a transportation section where heating units H1 to H4 described later are located will be called a “first section.” As shown in FIG. 3 and others, a part of the web paper WP corresponding to the first section will be defined as web paper WPa. The guide rollers R1 to R6 transport the web paper WPa in the first section. Among the guide rollers R, the guide roller R7 is a guide roller R located downstream from the first section and at the closest position to the first section.

Regarding the section where the web paper WP is transported, a section of transportation from the guide roller R7 to the printing face contact roller 29 will be called a “second section.” More specifically, as shown in FIG. 3 and others, a section from a contact point P2 between the web paper WP and the guide roller R7 to a contact point P3 between the web paper WP and the printing face contact roller 29 corresponds to the second section. As shown in FIG. 3 and others, a part of the web paper WP corresponding to the second section will be defined as web paper WPb.

Regarding the section where the web paper WP is transported, a section of transportation by the transport roller 31 will be called a “third section.” More specifically, as shown in FIG. 3 and others, a section downstream from the contact point P3 between the web paper WP and the printing face contact roller 29 correspond to the third section. As shown in FIG. 3 and others, a part of the web paper WP corresponding to the third section will be defined as web paper WPc.

Each path changing roller 33 is located downstream from each guide roller R and upstream from the printing face contact roller 29 in the transportation direction TD of the web paper WP. Specifically, the path changing roller 33 is located downstream from the guide roller R7. In this embodiment, four path changing rollers 33 are provided. As shown in FIGS. 2 and 3, the path changing rollers 33 are distinguished from each other by giving the path changing rollers 33 respective signs 33A to 33D in order from the upstream side of the transportation direction of the web paper WP. Specifically, among the path changing rollers 33, the path changing roller 33A is located on the most upstream side and the path changing roller 33D is located on the most downstream side.

Each path changing roller 33 changes the transportation path of the web paper WPb in the second section by coming into contact with the rear face BF of the web paper WPb in the second section. Specifically, by winding the web paper WPb in the second section around each path changing roller 33, the transportation path of the web paper WP is bent to be changed from a straight path Wv indicated by a dotted line in FIG. 3 to a path diverted from the straight path Wv. The path indicated by the sign WPb and solid lines in FIG. 3 and others and diverted from the straight path Wv is longer than the straight path Wv. Specifically, each path changing roller 33 extends the path of the web paper WPb in the second section.

### (B) Configuration of Heating Unit

The drying mechanism 21 includes the four heating units H1 to H4. The four heating units H1 to H4 heat the web paper WP guided into the drying mechanism 21. The heating unit H1, the heating unit H2, the heating unit H3, and the heating unit H4 are located in this order along the transportation path of the web paper WP. Specifically, among the four heating units H1 to H4, the heating unit H1 is located on the most upstream side. The heating units H1 to H4 heat the web paper WP in a state of not contacting the web paper WP.

The heating unit H1 is located face-to-face with the printing face FF of the web paper WP between the guide roller R1 and the guide roller R2. Specifically, the heating unit H1 is arranged adjacent to the printing face FF of the web paper WP transported between the guide roller R1 and the guide roller R2.

The heating unit H2 is located face-to-face with the printing face FF of the web paper WP between the guide roller R2 and the guide roller R3. The heating unit H3 is located face-to-face with the printing face FF of the web paper WP between the guide roller R3 and the guide roller R4. The heating unit H4 is located face-to-face with the printing face FF of the web paper WP between the guide roller R6 and the guide roller R7. Specifically, each of the four heating units H1 to H4 of the present embodiment is not arranged face-to-face with the rear face BF of the web paper WP.

The web paper WP is transported between the guide roller R4 and the guide roller R6 without being heated by a heating unit. The reason for this is as follows. The printing face FF is pointed downward between the guide roller R4 and the guide roller R6. Thus, directing a front surface (heating-side surface) of a heating unit toward the printing face FF makes the front surface of the heating unit face upward. Hence, if the web paper WP slackens, the web paper WP comes into contact with the front surface of the heating unit to be overheated. Then, in order to avoid overheating of the web paper WP, the web paper WP is transported between the guide roller R4 and the guide roller R6 without being heated by a heating unit.

As described above, each of the heating units H1 to H4 is located face-to-face with the printing face FF of the web paper WP in the first section. Each of the heating units H1 to H4 directly heats the web paper WP in the facing location in the first section to dry ink on the printing face FF.

As an example, each of the heating units H1 to H4 heats the printing face FF of the web paper WP with light (electromagnetic wave) including infrared rays. If the web paper WP is heated with light, each of the heating units H1 to H4 is preferably located in such a manner as to heat the printing face FF of the web paper WP transported between two of the guide rollers R next to each other. As an example, the heating unit H1 heats the web paper WP with light transported between the guide roller R1 and the guide roller R2 next to each other. Here, a region of light irradiation (heating region) by the heating unit H1 is determined not to cover the guide roller R1 and the guide roller R2. By determining arrangement in such a manner as to eliminate the guide roller R from the heating region, it becomes possible to prevent overheating of the guide roller R. This also applies to the other heating units H2 to H4.

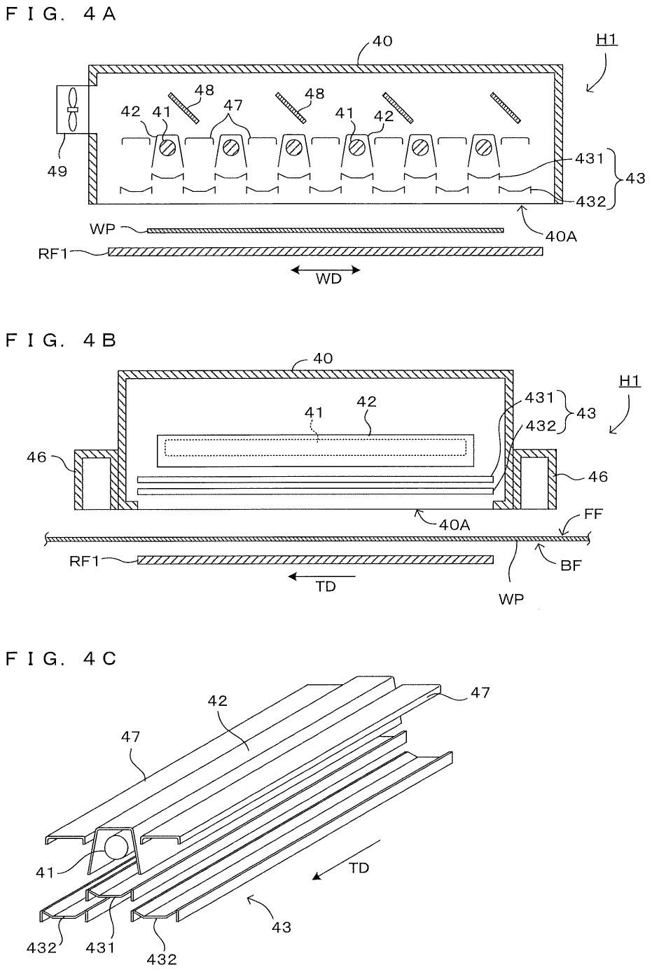

The configurations of the heating units H1 to H4 will be described below in more detail. The heating units H1 to H4 are to fulfill functions that are basically common to each other, so that they can be formed using units of the same configuration. Then, the configuration of one heating unit H1 will be described as a representative by referring to FIGS. 4A to 4C.

FIGS. 4A to 4C show an internal configuration of the heating unit. More specifically, FIG. 4A is a longitudinal sectional view of the heating unit H1 taken in a width direction WD of the web paper WP. FIG. 4B is a longitudinal sectional view of the heating unit H1 taken in the transportation direction TD of the web paper WP. The width direction WD is orthogonal to the transportation direction TD. FIG. 4C is a perspective view showing a partial configuration inside the heating unit H1.

The heating unit H1 includes a plurality of heaters 41 to emit light including infrared rays to the web paper WP. The heaters 41 are carbon (graphite) heaters, for example. The heaters 41 are aligned flatwise in the width direction WD. Each heater 41 is formed into a rod-like shape, and is located longitudinally in the transportation direction TD. The heaters 41 are located two-dimensionally at a constant interval therebetween in a direction crossing the longitudinal directions thereof. The number of the heaters is not limited to that illustrated in the drawings but is determined freely. As an example, a heater bent along one plane may be provided. A heating element other than the carbon heater may be used.

Applying light to the printing face FF from the heater 41 allows the printing face FF (ink and web paper WP) to be heated directly. Using the heater 41 allows application of light of a wavelength optimum for heating (drying) the ink. Specifically, the heater 41 can apply light of a wavelength having a favorable property of absorbing water.

The heaters 41 are accommodated in a casing 40. The casing 40 is formed into a rectangular solid shape having one opened face. An opened face 40A of the casing 40 may be provided with a grid fence for avoiding contact between the web paper WP and the heater 41. A peripheral surface of the heater 41 is surrounded by a reflection cover 42 except in a direction facing the opened face 40A. This allows light generated by the heater 41 to be guided toward the opened face 40A and to be emitted to the outside efficiently.

A shutter 43 is provided between the heaters 41 arranged in this way and the opened face 40A. The shutter 43 includes a plurality of movable plates 431 arranged at a constant interval therebetween and a plurality of fixed plates 432 arranged at a constant interval therebetween, and these plates are used for partially shielding light emitted from the heaters 41. Among these plates, the movable plate 431 is located closer to the heater 41 than the fixed plate 432 and separated from the fixed plate 432. The movable plate 431 is movable in the width direction WD, and as described later, has the function of opening and closing an optical path of light from the heater 41 toward the web paper WP. In this way, the quantity of light to be applied to the web paper WP is adjusted.

As shown in FIG. 4C, each of the movable plate 431 and the fixed plate 432 is a plate-like member having an M-shape section stretched laterally while extending in the transportation direction TD. Here, the movable plate 431 and the fixed plate 432 are formed into the same shape to encourage cost reduction. However, these plates may be formed into different shapes in response to a purpose.

Forming each of the movable plate 431 and the fixed plate 432 into the above substantially M-shape provides higher mechanical strength than in a case of forming into a simply flat plate. Moreover, each of the movable plate 431 and the fixed plate 432 is formed into a shape having a face facing the heater 41 where opposite ends thereof project toward the heater 41. This allows light radially emitted from the heater 41 to be shielded more effectively.

The heating unit H1 further includes a blower fan 49 and a guide plate 48. The blower fan 49 is provided on a side face of the casing 40 and driven by an electric motor not shown in the drawings. The blower fan 49 feeds gas into the casing 40. By doing so, it becomes possible for gas around the heater 41 warmed by the heater 41 to be fed to the printing face FF. The guide plate 48 is provided inside the casing 40, and guides a flow of the gas formed by the blower fan 49 toward the heater 41. A regulator plate 47 is located in a gap between a plurality of the reflection covers 42 surrounding the corresponding heaters 41, and the gas flow from the blower fan 49 flows out to the outside through the gap. The regulator plate 47 and the guide plate 48 are configured to cause air flow coming from the opened face 40A of the casing 40 to flow uniformly.

The regulator plate 47 further has the function of preventing the gas warmed by the heater 41 from scattering into internal space in the casing 40 opposite to the opened face 40A. This achieves improvement in heat energy efficiency.

The heating unit H1 includes two exhaust parts 46. The two exhaust parts 46 are provided on an upstream side face and a downstream side face of the casing 40 so as to sandwich the casing 40 accommodating the heater 41 and others in the transportation direction TD of the web paper WP. The two exhaust parts 46 each have an opening directed toward the printing face FF. This allows warmed gas blown through the opened face 40A by the blower fan 49 to be collected and exhausted on the upstream side and the downstream side of the casing 40. The number of the exhaust parts 46 at the heating unit H1 may be changed, if appropriate.

As shown in FIG. 2, the printing apparatus 1 includes four reflectors RF1 to RF4. Among these reflectors, the reflector RF1 is located opposite to the heating unit H1 across the web paper WP transported between the guide roller R1 and the guide roller R2. Likewise, the reflector RF2 is located opposite to the heating unit H2 across the web paper WP transported between the guide roller R2 and the guide roller R3. The reflector RF3 is located opposite to the heating unit H3 across the web paper WP transported between the guide roller R3 and the guide roller R4. The reflector RF4 is located opposite to the heating unit H4 across the web paper WP transported between the guide roller R6 and the guide roller R7.

Each of the four reflectors RF1 to RF4 is made of lustrous metal. Each of the four reflectors RF1 to RF4 reflects light having been applied from the heater 41 and transmitted through the web paper WP. The reflected light can be applied again to the web paper WP. This achieves effective use of the light applied from the heater 41.

As shown in FIG. 2 and others, the respective opened faces 40A of the heating units H1 to H4 are located in such a manner as to surround the web paper WPa in the first section and the web paper WPb in the second section. By employing this arrangement, a temperature in the space where the web paper WPa and the web paper WPb are transported is increased easily by the heating units H1 to H4. This facilitates drying of ink printed on the web paper WPa and the web paper WPb.

The drying mechanism 21 further includes an exhaust gas collecting unit (not shown in the drawings). The exhaust gas collecting unit is located above the rollers 13A, R1 to R7, 31 and 33, and the four heating units H1 to H4. The exhaust gas collecting unit is connected to the respective exhaust parts 46 of the four heating units H1 to H4. The exhaust gas collecting unit collects gas sucked from each of the exhaust parts 46, and feeds the collected gas to the outside of the printing apparatus 1, more specifically, to an exhaust duct at a building where the printing apparatus 1 is installed.

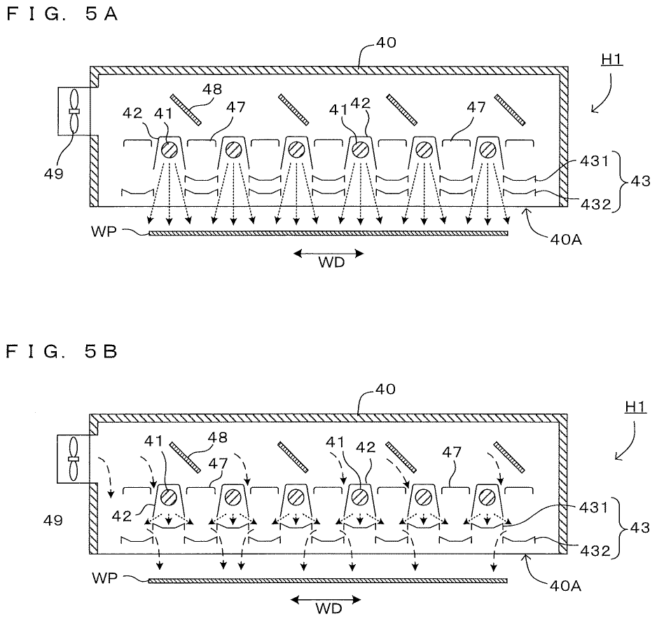

FIGS. 5A and 5B show two modes implemented by the drying mechanism. FIG. 5A corresponds to a first mode where intensive light emitted from the heater 41 is caused to enter the web paper WP directly, thereby applying heat of a large quantity to the web paper WP. In the first mode, the movable plate 431 is located at a position substantially overlapping the fixed plate 432 in the width direction WD. As a result, as indicated by dotted arrows in FIG. 5A, a path of light is formed along which the light from the heater 41 directly enters the web paper WP. In the present specification, the position of the movable plate 431 in this case is called an “opening position” as this position results in opening of the path of light from the heater 41 toward the web paper WP.

In this case, a comparatively large current is fed to the heater 41 to increase the quantity of light output from the heater 41. Thus, a large quantity of heat is applied to the web paper WP by heat radiation from the heater 41, making it possible to rapidly dry ink attached to the web paper WP. The first mode is suitable in a case where the web paper WP is transported at a high speed, for example.

FIG. 5B corresponds to a second mode where the web paper WP is heated indirectly by blowing warmed gas to the web paper WP instead of causing light emitted from the heater 41 to enter the web paper WP directly. The second mode is suitable in a case where the web paper WP is transported at a low speed, for example.

In the second mode, the movable plate 431 is located in such a manner as to close a gap between the fixed plates 432 next to each other. Thus, light emitted from the heater 41 is shielded by the movable plate 431 and the fixed plates 432 and does not enter the web paper WP directly. In this sense, in the present specification, the position of the movable plate 431 in this case is called a “shielding position.”

In this case, a current smaller than that in the first mode is fed to the heater 41. Thus, the quantity of light output from the heater 41 also becomes smaller than that in the first mode. As indicated by dotted arrows in FIG. 5B, light emitted from the heater 41 in this case is applied to the movable plate 431, the fixed plate 432, and their surrounding members to heat temperatures at these plates and members. Thus, a surrounding gas is warmed and is blown as warmed gas onto the web paper WP by the operation of the blower fan 49, as indicated by dashed arrows in FIG. 5B. In this way, in the second mode, the web paper WP is heated gently with the warmed gas.

In the first mode, the blower fan 49 also operates. However, heating by radiation is dominant and contribution by the warmed gas is relatively low. For this reason, the illustration of a gas flow is omitted from FIG. 5A to avoid complication of the drawing.

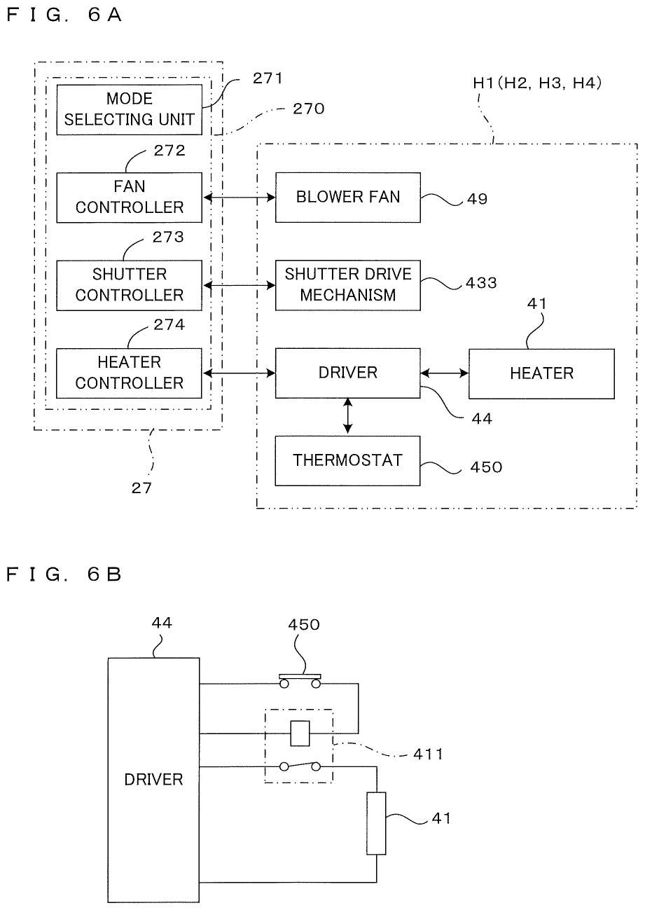

FIGS. 6A and 6B are block diagrams showing the configuration of the controller relating to control over the drying mechanism. In the controller 27, a CPU 270 executes a program set in advance to realize various functional blocks necessary for operating the units in the apparatus. As shown in FIG. 6A, functional blocks relating to control over the operation of the drying mechanism 21 include a mode selecting unit 271, a fan controller 272, a shutter controller 273, a heater controller 274, and the like. In the controller 27, other functional blocks are realized such as those for performing printing operation by controlling the units in the printing apparatus 1 including the printing unit 19 and the transport system.

The mode selecting unit 271 selects the first mode or the second mode to be implemented in response to a substance of printing operation to be performed. The fan controller 272 actuates the blower fan 49 when needed.

The shutter controller 273 controls a shutter drive mechanism 433 provided at the shutter 43 to control an open-closed state of the shutter 43. More specifically, if the first mode is selected, the shutter controller 273 actuates the shutter drive mechanism 433 to locate the movable plate 431 at the “opening position.” On the other hand, if the second mode is selected, the shutter controller 273 actuates the shutter drive mechanism 433 to locate the movable plate 431 at the “shielding position.”

The heater controller 274 controls a driver 44 to feed a current to the heater 41, thereby emitting heat of a predetermined quantity from the heater 41. More specifically, output from the heater 41 is controlled by adjusting a current amount to be applied from the driver 44 to the heater 41 in response to a control command given from the heater controller 274.

The heating unit H1 is further provided with a protective mechanism for preventing abnormal heating by the heater 41. Specifically, the driver 44 is provided with a current cutoff element that is a thermostat 450, for example, for detecting heat and cutting off a current. The thermostat 450 is located at a position where the thermostat 450 is heated by the heater 41. The thermostat 450 is interposed in a current path and cuts off the current path if a temperature thereof increased to a cutoff temperature specific to the element. This cutoff is done forcedly independently of control from outside. Even on the occurrence of abnormal heating due to trouble in a control system, the heating can still be stopped by cutting off a current immediately. Therefore, it is possible to realize the high-reliable protective mechanism.

The thermostat 450 may be provided along a current feed path to the heater 41. Meanwhile, as a large current flows in the heater 41, a thermostat to be provided along a path of such a current is required to be responsive to a large allowable current. Instead of this, as shown in FIG. 6B, the thermostat 450 can be provided along a path of a control current for turning on and off a switch (more specifically, a relay 411) interposed in the current feed path to the heater 41, for example.

If the thermostat 450 is increased in temperature to the cutoff temperature as a result of abnormal heating by the heater 41, a control current in the relay 411 is cut off. This opens a normally-closed contact to cut off the current feed path to the heater 41. By doing so, it becomes possible to avoid flow of a large current in the thermostat 450.

To explain the principle, the relay with the mechanical contact is shown as an example. Alternatively, a relay allowing turning on and off of a current path without a mechanical contact such as a solid state relay or a thyristor is available in an actual apparatus.

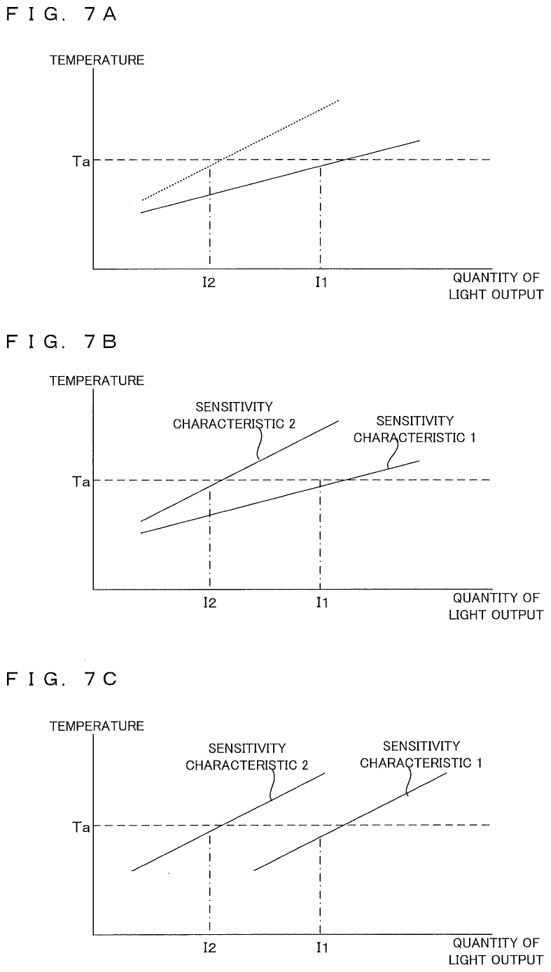

The protective mechanism using the thermostat 450 will be described in more detail. In this embodiment, the two modes of different quantities of light output from the heater 41 are implemented selectively, as described previously. The protective mechanism is required to provide compatibility between these two modes. This is achieved by employing the following idea. In the following, description will be given using FIGS. 7A to 9 on the assumption that the thermostat 450 is increased in temperature by causing light emitted from the heater 41 to enter the thermostat 450 itself. However, it is not essential to cause the emitted light to enter the thermostat 450 itself. Specifically, the thermostat 450 may be configured to be increased in temperature by integrating the thermostat 450 and some light-receiving member thermally with each other, making the light-receiving member receive the light emitted from the heater 41, and increasing a temperature at the light-receiving member.

FIGS. 7A to 7C show the idea of the protective mechanism using the thermostat. Regarding a graph in each of the drawings, a horizontal axis shows the magnitude of the quantity of light output from the heater 41, and a vertical axis shows a temperature at the thermostat 450. A sign Ta indicates a cutoff temperature of the thermostat 450. A correlation between the quantity of light output from the heater 41 and a temperature at the thermostat 450 mentioned herein will be called a “sensitivity characteristic” of the thermostat 450.

By referring to FIG. 7A, consideration is first given to a case where the thermostat 450 is provided fixedly at an appropriate position. As shown by a solid line and a dotted line in FIG. 7A, if the thermostat 450 is provided at a position where the thermostat 450 is increased in temperature by radiation from the heater 41, a temperature at the thermostat 450 becomes higher as the quantity of light output from the heater 41 becomes larger. When the temperature reaches the cutoff temperature Ta, the thermostat 450 is actuated to cut off the current path.

Here, the quantities of light output from the heater 41 in the first mode and the second mode will be indicated by signs I1 and I2 respectively. As indicated by the solid line in FIG. 7A, a protective function suitable in the first mode may be achieved by making a temperature at the thermostat 450 slightly lower than the cutoff temperature Ta at the output light quantity I1 and making a temperature at the thermostat 450 greater than the cutoff temperature Ta if an output light quantity increases to exceed an allowable value. This condition can be fulfilled by selecting a product having the appropriate cutoff temperature Ta as the thermostat 450 and installing the thermostat 450 on a suitable position.

On the other hand, as the output light quantity I2 in the second mode is smaller, a temperature at the thermostat 450 is also lower in this case. This makes an output light quantity considerably larger than the intended value I2 when the thermostat 450 reaches the cutoff temperature Ta. Hence, it cannot be said that a protective function responsive to the second mode works effectively.

Conversely, as indicated by the dotted line in FIG. 7A, if setting is made in such a manner that the protective function works effectively in the second mode, a temperature at the thermostat 450 exceeds the cutoff temperature Ta in the first mode even if the output light quantity I1 is proper to actuate the current cutoff function. Hence, it becomes impossible to implement the first mode.

If the positions of the heater 41 and the thermostat 450 relative to each other are set fixedly as described above, it is difficult to make both the first mode and the second mode implementable and to effectively fulfill the respective protective functions in these modes.

In response to this, as shown in FIGS. 7B and 7C, changing the sensitivity characteristic of the thermostat 450 between the first mode and the second mode allows the two modes to be compatible with each other. In each of FIGS. 7B and 7C, a “sensitivity characteristic 1” shows an example of a sensitivity characteristic responsive to the first mode, and a “sensitivity characteristic 2” shows an example of a sensitivity characteristic responsive to the second mode. FIG. 7B shows a case where a gradient differs between the two sensitivity characteristics. FIG. 7C shows a case where a segment differs between the two sensitivity characteristics.

For using these sensitivity characteristics properly, it is necessary to fulfill a condition under which, even if the quantities of light output from the heater 41 are equal to each other, temperatures at the thermostat 450 responsive to these quantities increase in different ways. As an example, a way in which light emitted from the heater 41 enters the thermostat 450 is changed. By doing so, even if the quantities of light output from the heater 41 are equal to each other, a difference is generated between the quantities of light to enter the thermostat 450, thereby making it possible to increase a temperature at the thermostat 450 to different degrees.

The above change in the sensitivity characteristic can be realized by changing a distance between the heater 41 and the thermostat 450 or changing a viewing angle from the thermostat 450 to the heater 41, for example, to change a way in which light emitted from the heater 41 enters the thermostat 450. The sensitivity characteristic can also be changed by shielding part of light from the heater 41 to enter the thermostat 450 to change a way in which the light from the heater 41 enters the thermostat 450. Specific examples based on this idea will be described below.

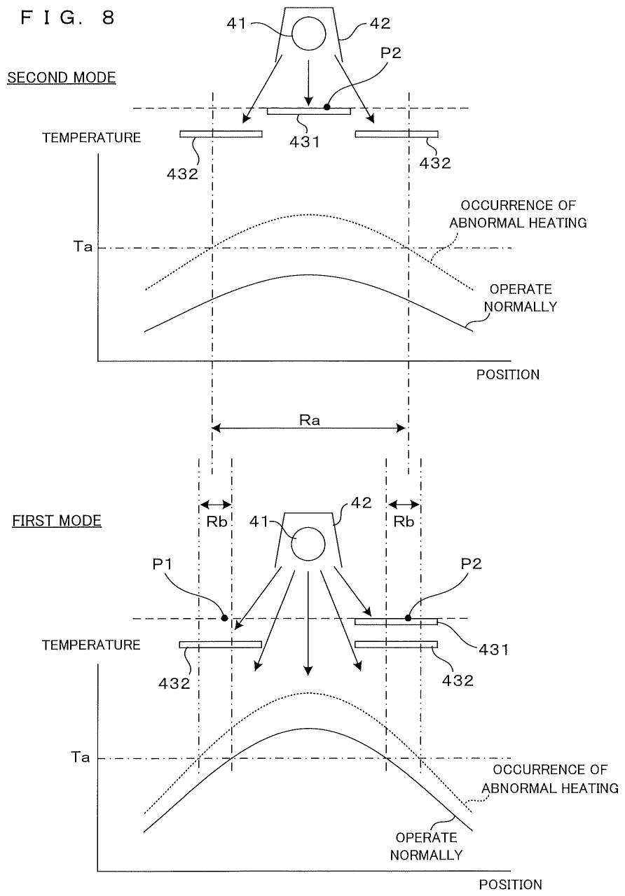

FIG. 8 shows a relationship between the open-closed state of the shutter and a temperature distribution. In the following description, the shapes of the movable plate 431 and the fixed plate 432 of the shutter 43 are simplified as flat-plate shapes. Here, on the assumption that the thermostat 450 is located at any position corresponding to an upper surface of the movable plate 431 in a height direction (dashed line), for example, consideration will be given to a position that allows the two modes to be compatible with each other.

An upper view of FIG. 8 schematically shows a temperature distribution in the second mode measured at each position corresponding to the height of the upper surface of the movable plate 431 indicated by the dashed line observed in each of a case where the heater 41 operates normally and a case on the occurrence of abnormal heating. In the second mode, the shutter 43 is in the “closed” state, namely, the movable plate 431 is at the “shielding position” of shielding light output from the heater 41. The quantity of the light output from the heater 41 is smaller than that in the first mode described later. Note that a temperature to be considered here is a temperature at the height of the upper surface of the movable plate 431 indicated by the dashed line. Thus, influence by radiant heat from the heater 41 is dominant independently of the open-closed state of the shutter 43.

As indicated by a solid line in this view, if the heater 41 operates normally, a temperature becomes highest at a position immediately below the heater 41 and decreases with a greater distance from the heater 41. As indicated by a dotted line, if the heater 41 generates heat excessively, a temperature also tends to become highest at the position immediately below the heater 41 like in the normal case but the value of the temperature itself becomes higher than that in the normal case. Thus, if the thermostat 450 having the cutoff temperature Ta higher than a maximum temperature in a temperature distribution in the normal case and lower than a maximum temperature on the occurrence of abnormal heating is located within a region Ra where a temperature exceeds the cutoff temperature Ta on the occurrence of abnormal heating, the protective function in the second mode is implemented. The reason for this is that, while a temperature at the thermostat 450 does not exceed the cutoff temperature Ta so current cutoff does not occur in the normal time, a temperature at the thermostat 450 becomes higher than the cutoff temperature Ta to cut off a current on the occurrence of abnormal heating.

A lower view of FIG. 8 schematically shows a temperature distribution in the first mode. In this case, the shutter 43 is in the “open” state, namely, the movable plate 431 is at the “opening position” of causing light output from the heater 41 to pass through. The quantity of light output from the heater 41 is larger than that in the second mode. Thus, a temperature at the height of the upper surface of the movable plate 431 indicated by the dashed line is higher than that in the second mode. The temperature still becomes higher on the occurrence of abnormal heating.

Here, a region Rb where a temperature in the normal case does not exceed the cutoff temperature Ta and a temperature on the occurrence of abnormal heating exceeds the cutoff temperature Ta is a region where the thermostat 450 is to be located for making the protection work appropriately in the first mode. Specifically, locating the thermostat 450 in the region Rb realizes the appropriate protective function in the first mode.

Then, the position of the thermostat 450 may be determined so as to fulfill the condition that the position is within the region Rb in the first mode and within the region Ra in the second mode. This condition may be fulfilled by at least two possible methods described below.

First, if the region Rb preferred in the first mode and the region Ra preferred in the second mode spatially overlap each other partially, the thermostat 450 can be located within the overlapping region. In the illustrations in FIG. 8, such an overlap is observed and the requirement is fulfilled at a point P1 within the overlapping region, for example.

As a second method, the position of the thermostat 450 is changed so as to fulfill the requirement in each of the two modes. As the position of the movable plate 431 of the shutter 43 is changed between the modes, for example, moving the thermostat 450 in conjunction with this position change may make it possible to fulfill the requirement in each of the two modes. A point P2 on the movable plate 431 is within the region Ra in the second mode shown in the upper view, for example, so that the point P2 is preferred as a location of the thermostat 450 in the second mode.

On the other hand, the position of the point P2 deviates from the region Rb preferred in the first mode. However, if the thermostat 450 is located at the point P2 on the movable plate 431, the point P2 moves into the region Rb in response to the movement of the movable plate 431 in the first mode shown in the lower view. In this way, the protective function also works appropriately in the fist mode.

Thus, the point P2 existing on the movable plate 431 and to move integrally with the movable plate 431 can be said to be a point that fulfills the requirement for making both the protective functions in the two modes effective. In the upper view of FIG. 8 (second mode), light emitted from the heater 41 enters the point P2 (the location of the thermostat 450) substantially vertically. On the other hand, in the lower view of FIG. 8 (first mode), light emitted from the heater 41 enters the point P2 in a state of tilting from the point P2. As described above, a way in which light emitted from the heater 41 enters the point P2 as the location of the thermostat 450 or a thermostat unit 45 described later differs between the second mode shown in the upper view of FIG. 8 and the first mode shown in the lower view of FIG. 8. Providing compatibility between the protections in the two modes by changing a way of light incidence in this way also applies to a case where there is no overlap between the “preferred regions” in the two modes, as described next.

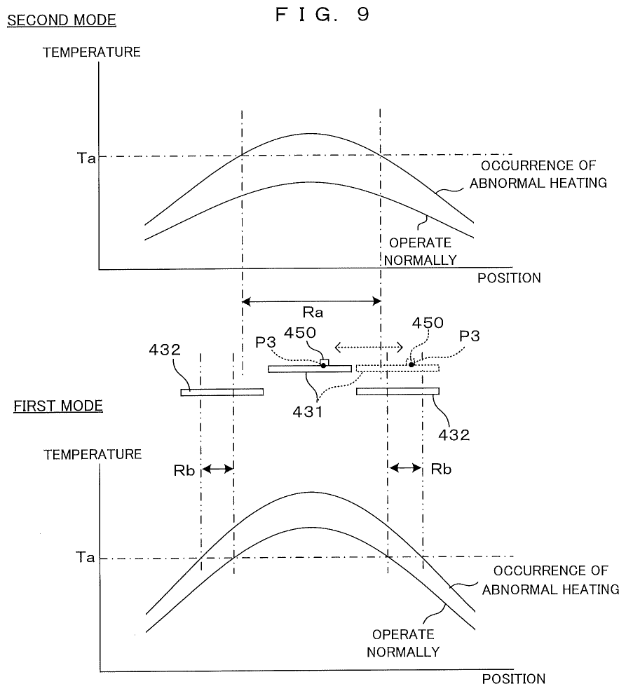

FIG. 9 shows a case where there is no overlap between the preferred regions in the two modes. As a result of differences in output from the heater 41, the dimensions of members, etc., various temperature distributions may be observed. In one case, as described above, there is no overlap between the preferred regions in the two modes. In the illustration of FIG. 9, there is no overlap between the region Ra preferred in the second mode and the region Rb preferred in the first mode.

However, locating the thermostat 450 at a point P3 on the movable plate 431 of the shutter 43 allows the thermostat 450 to be located in a region preferred in each of the modes. In FIG. 9, the positions of the movable plate 431 and the thermostat 450 in the second mode are indicated by solid lines, and the positions of the movable plate 431 and the thermostat 450 in the first mode are indicated by dotted lines. This shows fulfillment of the requirement that the thermostat 450 be within the region Ra in the second mode and the thermostat 450 be within the region Rb in the first mode.

Thus, the protective function responsive to abnormal heating works effectively in each of the first mode and the second mode. More specifically, in the second mode, the thermostat 450 is within the region Ra. Thus, the current cutoff function of the thermostat 450 does not work in the case of normal heating and drying of the web paper WP can be facilitated by supplying heat generated by the heater 41 as warmed gas to the web paper WP. On the other hand, on the occurrence of abnormal heating, the current cutoff function of the thermostat 450 stops the heating by the heater 41. Thus, the web paper WP is prevented from being increased to an abnormally high temperature.

Likewise, as the thermostat 450 is within the region Rb in the first mode, the current cutoff function of the thermostat 450 does not work in the case of normal heating. Therefore, drying of the web paper WP can be facilitated by causing light emitted from the heater 41 to enter the web paper WP directly. On the other hand, on the occurrence of abnormal heating, the current cutoff function of the thermostat 450 stops the heating by the heater 41. Thus, the web paper WP is prevented from being increased to an abnormally high temperature.

In the second mode, the thermostat 450 is at a position near a position immediately below the heater 41. On the other hand, in the first mode, a distance between the thermostat 450 and the heater 41 is larger. Thus, even in the first mode where the quality of output light is large, temperature increase at the thermostat 450 is still suppressed to prevent the cutoff function from working with unnecessary timing.

In this embodiment, the thermostat 450 is located at a position on the movable plate 431 that corresponds either to the point P2 in FIG. 8 or to the point P3 in FIG. 9. Thus, there is no intervention of the thermostat 450 during normal time. On the occurrence of abnormal heating, current cutoff by the thermostat 450 stops the heating by the heater to protect the web paper WP and the apparatus itself. This function works effectively in both the first mode and the second mode.

In this embodiment, to make the protective function more effective, the following measure is taken in relation to the location of the thermostat 450 on the movable plate 431.

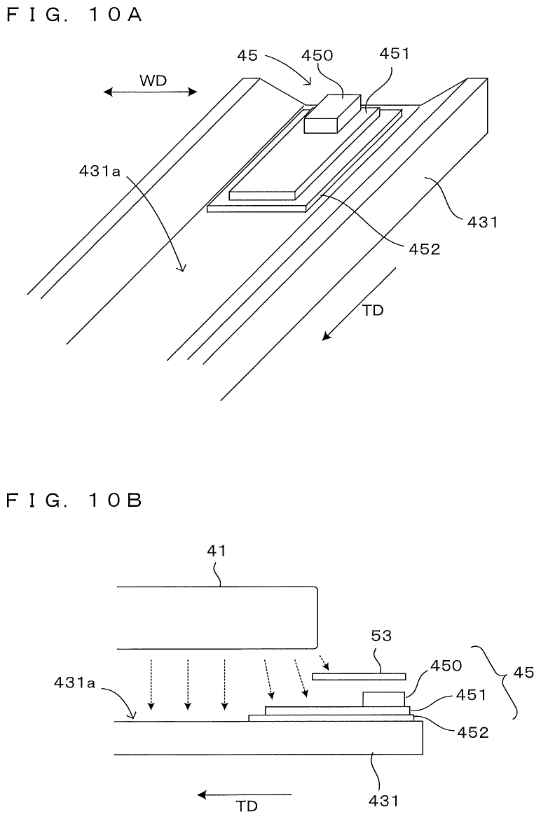

FIGS. 10A and 10B show a state where the thermostat is mounted on the movable plate. More specifically, the movable plate 431 is mounted with the thermostat unit 45 including at least the thermostat 450. The thermostat unit 45 includes the thermostat 450, a light-receiving plate 451, and a heat-insulating plate 452. FIG. 10A is a partial perspective view and FIG. 10B is a side view showing the thermostat unit 45 mounted on the movable plate 431. As shown in FIG. 10A, the thermostat unit 45 is provided in such a manner that the light-receiving plate 451 and the heat-insulating plate 452 are interposed between the thermostat 450 and an upper surface 431a of the movable plate 431. More specifically, the heat-insulating plate 452 is mounted in a flat area of a recess formed at the upper surface 431a of the movable plate 431. The light-receiving plate 451 is mounted on an upper surface of the heat-insulating plate 452 and does not contact the movable plate 431. The thermostat 450 is mounted on an upper surface of the light-receiving plate 451. The thermostat unit 45 is configured in this way.

As shown in FIG. 10B, the thermostat 450 is provided external to an end of the heater 41 in the transportation direction TD, and the light-receiving plate 451 extends from a position immediately below the thermostat 450 to a position internal to the end of the heater 41. A light-shielding plate 53 is located above the thermostat 450 and between the thermostat 450 and the heater 41. Thus, while light from the heater 41 indicated by doted arrows enters the light-receiving plate 451, it does not enter the thermostat 450 directly.

For this reason, instead of being increased in temperature by receiving light from the heater 41 directly, the thermostat 450 is increased in temperature with conductive heat from the heated light-receiving plate 451. Thus, even if output from the heater 41 is large like in the first mode, it is still possible to avoid the occurrence of failure or degradation of the thermostat 450 as a result of increasing the thermostat 450 to an abnormally high temperature with radiant heat from the heater 41. Thus, it is possible to fulfill the protective function against the abnormal heating stably for a long time.

In view of the purpose of detecting abnormal heating by the heater 41 immediately, temperature increase at the thermostat 450 is required to be highly responsive to heat generated by the heater 41. If the movable plate 431 is made of stainless steel, for example, temperature responsiveness to heat generated by the heater 41 is not high. Thus, in this case, it is desirable to prevent the thermostat 450 from being influenced by the temperature of the movable plate 431. In this embodiment, the light-receiving plate 451 is made of a material having higher heat conductivity such as copper or aluminum, for example, the thermostat 450 is mounted on the light-receiving plate 451, and furthermore, the heat-insulating plate 452 is provided between the light-receiving plate 451 and the movable plate 431. By doing so, influence by the temperature of the movable plate 431 is suppressed, making it possible to ensure excellent temperature responsiveness to the heat generated by the heater 41.

Each of these measures achieves certain degrees of action and effect alone. As described above, by using these measures in combination, it becomes possible to maintain the protective function capable of handling abnormal heating by the heater 41 with high temperature responsiveness stably for a long time.

The thermostat unit 45 may be provided only at one end or at each of both ends of the movable plate 431.

There is no particularly limitation on operation after feeding of the heater 41 is stopped to cause temperature decrease by the actuation of the thermostat 450. Specifically, heating by the heater 41 may be continued when current conduction is restarted in response to temperature decrease at the thermostat 450, or heating may be suspended until predetermined recovery work is done, for example.

If heating is to be restarted automatically after the temperature decrease, abnormal heating may be repeated unless a phenomenon leading to the abnormal heating is resolved. This problem may be handled by prohibiting restart of heating if the thermostat 450 makes cutoffs a predetermined number of times, for example.

In the heating unit H1 and others of this embodiment, the heaters 41 are arranged parallel to each other and the thermostats 450 are provided in one-to-one relationships with these heaters 41. A determination is made freely as to how to combine the protective functions to work individually at the respective thermostats 450 and heaters 41. As an example, the protective function may be configured to work independently at each heater 41. Alternatively, if the current cutoff function works at any of the thermostats 450, feeding to all the heaters 41 may be stopped. This may be achieved by connecting the thermostats 450 electrically in series.

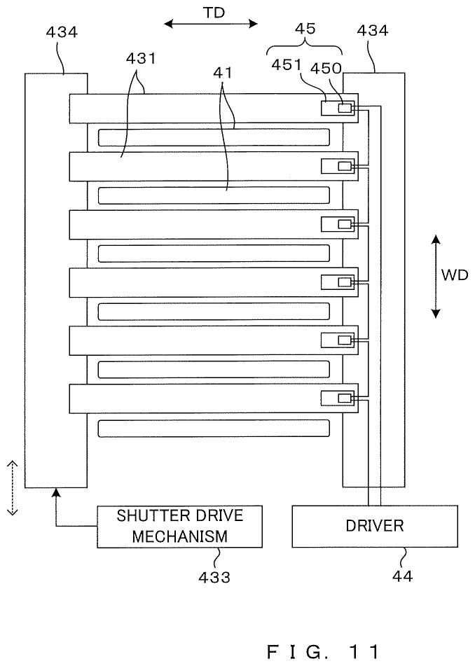

FIG. 11 shows a mechanism for interlocking the movable plates. In this drying mechanism 21, all the movable plates 431 are located at the opening positions in the first mode and are located at the shielding positions in the second mode. This eliminates a need for a mechanism for moving the movable plates 431 independently, and allowing the movable plates 431 to move integrally with each other is sufficient.

Thus, in one configuration, opposite ends of each of the movable plates 431 may be attached to frame members 434 in a pair external to opposite ends of the heater 41 in the transportation direction TD to unite all the movable plates 431 integrally with each other. The resultant unity is moved in the width direction WD by the shutter drive mechanism 433 as shown in FIG. 11, for example. An air cylinder or a rack-and-pinion mechanism driven to make direct motion by a motor is applied preferably, for example, as the shutter drive mechanism 433.

In this case, a wire extending from each thermostat 450 can be fixed to the frame member 434 to provide stable electrical connection. Moreover, extending the wire externally to the heater 41 can prevent the wire from being increased to a high temperature.

The positions of the movable plates 431 relative to each other do not change. Thus, particularly in a case of connecting all the thermostats 450 in series, it is possible to avoid complication of wiring and also to achieve optimum result in terms of electrical stability.

Some modifications of the above embodiment will be described below. In the following modifications, regarding a structure having a configuration and a function substantially the same as those of the above embodiment, this structure will be given the same sign as in the above embodiment and repeated description thereof will be omitted.

In the above embodiment, the thermostat unit 45 is mounted on the movable plate 431 of the shutter 43 and configured to be moved integrally with the movable plate 431. By doing so, the thermostat unit 45 is located at a position different between the first mode and the second mode to cause the protective functions to work appropriately in the corresponding modes. This is intended to achieve an advantage that opening and closing of the shutter and locating the thermostat unit 45 at an optimum position can be realized simultaneously using the same drive mechanism.

In some cases, however, it may be impossible for the position of the thermostat unit 45 providing compatibility between the two modes to be set within a range of movement of the movable plate 431. In such cases, a mechanism for moving the thermostat unit 45 independently of the movable plate 431 may be provided additionally and the thermostat unit 45 may be configured to be located at a position optimum for each of the two modes.

In the above embodiment, the position of the thermostat unit 45 relative to the heater 41 is changed in order for a way of incidence of light from the heater 41 into the thermostat unit 45 to be changed between the two modes. The “incidence of light into the thermostat unit” mentioned herein is a concept covering not only a case where light directly enters the thermostat 450 as the current cutoff element belonging to the thermostat unit 45 but also a case of “indirect” incidence where light enters the light-receiving plate 451 for transmitting heat to the thermostat 450.

In essence, it is simply required to change a ratio of a component as part of light emitted from the heater 41 and to contribute to temperature increase at the thermostat 450 by changing a way of incidence of the light from the heater 41 into the thermostat unit 45. Specifically, it is simply required to make setting in such a manner that the ratio of the component as part of the light emitted from the heater 41 and to contribute to temperature increase at the thermostat 450 becomes smaller in the first mode than in the second mode.

As understood from this, the above setting is realized by providing some optical means between the heater 41 and the thermostat unit 45 instead of changing the position of the thermostat unit 45. More specifically, it is simply required to suppress temperature increase at the thermostat unit 45 in the first mode where a light quantity of large so a temperature at the thermostat unit 45 is increased easily. For example, a light-shielding plate may be provided between the heater 41 and the thermostat unit 45 and the light-shielding plate may operate differently between the first mode and the second mode.

If the light-shielding plate arranged between the heater 41 and the thermostat unit 45 in the first mode is retreated in the second mode, for example, sensitivity to output from the heater 41 changes without changing the position of the thermostat unit 45. Thus, by designing the light-shielding plate appropriately, it becomes possible to achieve effect comparable to that of the above embodiment. Further, the movable plate 431 is available as this light-shielding plate, as will be described next.

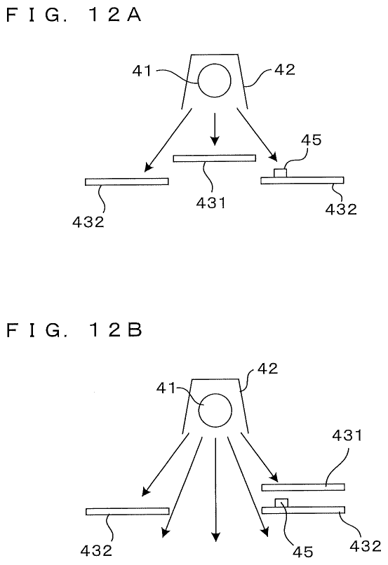

FIGS. 12A and 12B show an example where the movable plate is used as a light-shielding plate for the thermostat unit. The thermostat unit 45 in this modification is mounted on an upper surface of the fixed plate 432 of the shutter 43. FIG. 12A shows the second mode. In this case, the movable plate 431 is at the shielding position, so that the movable plate 431 does not function as a light-shielding plate for the thermostat unit 45. Thus, on the occurrence of abnormal heating by the heater 41, it is possible to detect the abnormal heating and cutoff a current immediately.

On the other hand, in the first mode shown in FIG. 12B, the movable plate 431 having moved to the opening position functions as a light-shielding plate for the thermostat unit 45. This suppresses temperature increase at the thermostat unit 45 to avoid a problem that, even during normal operation, the cutoff temperature Ta of the thermostat 450 is exceeded so the protective function works more than necessary.

Like in the above embodiment, in order to provide compatibility between the protective functions in these two modes, it is simply required to grasp a temperature distribution on the fixed plate 432 in each of the modes and set the cutoff temperature Ta and the location of the thermostat 450 appropriately in response to result of the grasping. In this case, it is also possible to employ the idea of the positional relationship with the heater 41, ideas of the light-receiving plate 451, the heat-insulating plate 452 and others shown in FIG. 10.

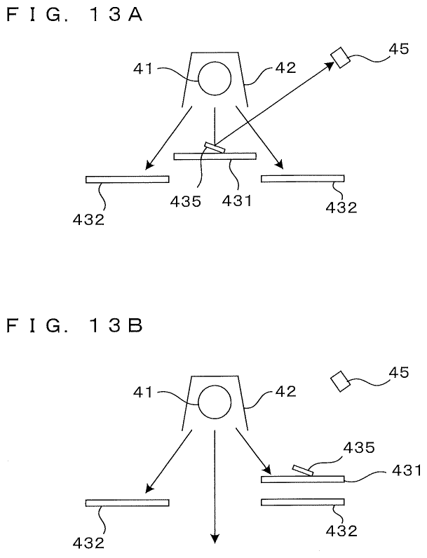

FIGS. 13A and 13B show another modification. In the above embodiment and modification, the thermostat unit 45 is located within or near a range of application with light from the heater 41. Alternatively, as shown in FIG. 13A, a reflecting mirror 435 may be provided on the movable plate 431 and the thermostat unit 45 may be arranged in an optical path of light emitted from the heater 41 and reflected on the reflecting mirror 435. Here, a surface shape, tilt, a position of mounting, etc. of the reflecting mirror 435 may be set in such a manner that, when the movable plate 431 is at the shielding position as shown in FIG. 13A, more reflected light enters the thermostat unit 45 than in a case where the movable plate 431 is at the opening position as shown in FIG. 13B.

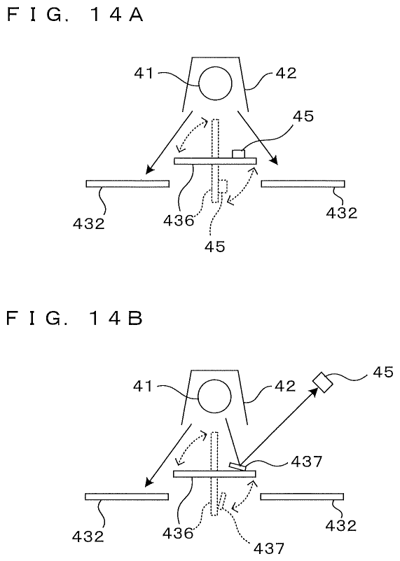

FIGS. 14A and 14B show other modifications. In the shutter 43 of the above embodiment, the movable plate 431 makes sliding movement to switch between the shielding position and the opening position. According to a type of such a shutter, the shutter may be opened and closed by pivotal motion of a flap. The modification described here includes a shutter 43a with such a flap. In the illustration of FIG. 14A, light from the heater 41 toward the web paper WP is shielded while a main surface of a flap 436 faces the heater 41 (solid lines), and this position of the flap 436 corresponds to the “shielding position.” On the other hand, when the flap 436 in this state rotates 90 degrees to make the main surface thereof parallel to a traveling direction of light (dotted lines), the function of shielding the light is limited to allow the light to enter the web paper WP directly. This position of the flap 436 corresponds to the “opening position.”

In this configuration, it is also possible to change the sensitivity characteristic of the thermostat unit 45 by providing the thermostat unit 45 at the flap 436 and changing a way of incidence of an infrared ray from the heater 41 between the shielding position and the opening position. By taking advantage of this point and, as needed, by further using a light-receiving plate, a light-shielding plate or the like, it becomes possible to provide compatibility between the protective functions in the two modes like in the above embodiment.

FIG. 14B shows a modification where a reflecting mirror 437 is provided on the flap 436. Like in this case, by taking advantage of change in the quantity of reflected light to reach the thermostat unit 45 in response to the position of the flap 436, it also becomes possible to achieve comparable effect.

As described above, in each of the above embodiments, the web paper WP corresponds to a “print medium” of the present application. Each of the paper feeder 3, the paper ejector 7, and the rollers provided along the transportation path functions as a “transport unit” of the present application. The drying mechanism 21 functions as a “drying device” of the present application. The heater 41 and the controller 27 respectively function as a “light source” and a “controller” of the present application.

In the above embodiment, the shutter 43 functions as a “light shield” of the present application, and particularly, the movable plate 431 corresponds to a “movable shutter” of the present application. The light-receiving plate 451, the heat-insulating plate 452, and the light-shielding plate 53 respectively function as a “light-receiving member,” a “heat-insulating member,” and a “shielding member” of the present application.

The thermostat 450 corresponds to a “current cutoff element” of the present application, and the thermostat unit 45 including the thermostat 450 corresponds to a “current cutoff unit” of the present application. The shutter drive mechanism 433 of the above embodiment further functions as a “sensitivity changing unit” of the present application by moving the thermostat unit 45 together with the movable plate 431. Furthermore, in the above embodiment, the current plate 47, the guide plate 48, and the blower fan 49 integrally function as a “gas flow generator” of the present application.

Note that the invention is not limited to the above embodiment, and various changes other than the aforementioned ones can be made without departing from the gist of the invention. As an example, the above embodiment employs the configuration where the protective functions against abnormal heating work appropriately in both the first mode where the quantity of light output from the heater 41 is large and the second mode where the quantity of the output light is smaller.

In the presence of these two modes of different quantities of output light, however, an essential minimum requirement is to fulfill contradicting conditions that the protective function work reliably in the second mode where a temperature is comparatively low and that the protective function be prevented from working more than necessary in the first mode where a temperature is higher (specifically, the protective function be prevented from working even if it is unnecessary).

In this sense, causing the protective function to work against abnormal heating also in the first mode can be said to be additional action and effect, and even a configuration without this requirement is implementable as an invention. For this reason, the location and the cutoff temperature of the thermostat may be set without giving consideration to the protective function in the first mode.

In the above embodiment, the thermostat unit 45 includes the thermostat 450, the light-receiving plate 451, and the heat-insulating plate 452. Meanwhile, the thermostat unit corresponding to the “current cutoff unit” of the present application is simply required to include at least the thermostat and is not essentially required to include the light-receiving plate and the heat-insulating plate.

In the above embodiment, the thermostat is used as the current cutoff element. Meanwhile, a different element having the same function may be used. If automatic recovery after cutoff is not required, for example, a thermal fuse is available as the current cutoff element.

In the above embodiment, the web paper WP (print medium) is heated in the second mode. Meanwhile, in the second mode, it is simply required to apply a heat quantity (including a substantially zero quantity) smaller than that in the first mode, and heating the print medium is not an essential in the second mode.

In the above embodiment, the present invention is applied to the printing apparatus 1 with the drying mechanism 21 provided therein. Meanwhile, in addition to application to such a drying mechanism provided in advance in a printing apparatus, the present invention is applicable to a device manufactured as an independent drying device.

The “print medium” of the present invention is not limited to the elongated print sheet (web paper) in the above embodiment but may be a short print medium (cut paper, for example). A material of the print medium is not limited to paper but may be a plastic film, a corrugated cardboard, or a material made of metallic foil or glass, for example.

As has been described above by presenting the specific embodiment as an example, in the drying device according to the present invention, the sensitivity changing unit may be configured to change the position of the current cutoff unit between the first mode and the second mode.

In this case, the light shield may include a movable shutter configured to move between a shielding position where the movable shutter shields light from the light source toward the print medium and an opening position where the movable shutter having retreated from the shielding position allows the light from the light source to enter the print medium directly, the movable shutter may be configured to be located at the opening position in the first mode and at the shielding position in the second mode, and the current cutoff unit may be configured to move integrally with the movable shutter and may be configured to be at a distance from the light source greater in the first mode than in the second mode. By increasing the distance between the light source and the current cutoff unit, temperature increase at the current cutoff unit is suppressed even in the first mode of a larger quantity of light output from the light source, making it possible to prevent the protective function from working more than necessary.

As an example, the current cutoff unit may be mounted on the movable shutter. This achieves movement of the movable shutter and change of the position of the current cutoff unit simultaneously.

In this case, the current cutoff unit may further include the heat-insulating member interposed between the current cutoff element and the movable shutter. This can make it unlikely that the operation of the current cutoff unit will be influenced by a temperature at the movable shutter.

As an example, the current cutoff element may be provided external to an end of the light source in a direction orthogonal to a movement direction of the current cutoff unit. Locating the current cutoff element external to the end of the light source suppresses direct incidence of the light, making it possible to encourage extension of lifetime of the current cutoff element. In this case, temperature change at the current cutoff element might become less responsive to change in the quality of output light. By providing the current cutoff unit with the light-receiving member where the light from the light source directly enters and mounting the current cutoff element on the light-receiving member, for example. A temperature at the current cutoff element is also increased with conductive heat from the light-receiving member. By doing so, it becomes possible to encourage improvement in the responsiveness.

For the same reason, a light-shielding member configured to shield the light from the light source to enter the current cutoff element may be provided between the current cutoff element and the light source while the movable shutter is at the opening position, for example.

As an example, the sensitivity changing unit may be configured to perform shielding of at least part of the light from the light source to enter the current cutoff unit in the first mode and to avoid the shielding in the second mode.

In particular, if the light shield includes the movable shutter configured to move between the shielding position where the movable shutter shields the light from the light source toward the print medium and the opening position where the movable shutter having retreated from the shielding position allows the light from the light source to enter the print medium directly, the movable shutter may be configured to be located at the opening position in the first mode and at the shielding position in the second mode, and the current cutoff element may be configured to be shielded by the movable shutter when the movable shutter is at the opening position and not to be shielded by the movable shutter when the movable shutter is at the shielding position as viewed from the light source.

As an example, the gas flow generator configured to generate a gas flow from the light source toward the print medium may be provided further. This configuration allows the print medium to be heated using warmed gas generated around the light source. As a result, it is possible to encourage improvement in energy efficiency.

As an example, a thermostat is used preferably as the current cutoff element according to the present invention.

The present invention is applied preferably to a printing apparatus for drying a print medium by heating after the print medium is printed with ink or the like.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A drying device for drying a print medium after the print medium is printed, the drying device comprising:
a light source which emits light toward the print medium in response to feed of a current;
a current cutoff unit which includes a current cutoff element configured to cut off the current to be fed to the light source if being increased to a higher temperature than a predetermined cutoff temperature;
a sensitivity changing unit which is configured to change a sensitivity characteristic indicating a correlation between a quantity of the light output from the light source and a degree of temperature increase at the current cutoff element by changing a way of incidence in which the light from the light source enters the current cutoff unit;
a light shield which is located between the light source and the print medium and changes a shielding ratio of shielding the light from the light source toward the print medium; and
a controller which is configured to selectively implement a first mode and a second mode differing from each other in the quantity of the output light and the shielding ratio, wherein:
the quantity of the output light is larger and the shielding ratio is smaller in the first mode than in the second mode; and
the sensitivity changing unit changes the sensitivity characteristic between the first mode and the second mode, thereby makes a temperature of the current cutoff element less than the cutoff temperature in each of the first mode and the second mode.

2. The drying device according to claim 1, wherein the sensitivity changing unit changes a position of the current cutoff unit between the first mode and the second mode.

3. The drying device according to claim 2, wherein:
the light shield includes a movable shutter configured to move between a shielding position where the movable shutter shields light from the light source toward the print medium and an opening position where the movable shutter having retreated from the shielding position allows the light from the light source to enter the print medium directly;
the movable shutter is located at the opening position in the first mode and at the shielding position in the second mode; and
the current cutoff unit moves integrally with the movable shutter and a distance from the light source to the current cutoff unit is greater in the first mode than in the second mode.

4. The drying device according to claim 3, wherein the current cutoff unit is mounted on the movable shutter.

5. The drying device according to claim 4, wherein the current cutoff unit includes a heat-insulating member interposed between the current cutoff element and the movable shutter.

6. The drying device according to claim 3, wherein the current cutoff element is provided external to an end of the light source in a direction orthogonal to a movement direction of the current cutoff unit.

7. The drying device according to claim 6, wherein the current cutoff unit includes a light-receiving member to which the light from the light source directly enters, and the current cutoff element is disposed to the light-receiving member.

8. The drying device according to claim 3, wherein a light-shielding member to shield the light from the light source to the current cutoff element is provided between the current cutoff element and the light source while the movable shutter is at the opening position.

9. The drying device according to claim 1, wherein the sensitivity changing unit performs shielding of at least part of the light from the light source to enter the current cutoff unit in the first mode and avoids the shielding in the second mode.

10. The drying device according to claim 9, wherein
the light shield includes a movable shutter configured to move between a shielding position where the movable shutter shields light from the light source toward the print medium and an opening position where the movable shutter having retreated from the shielding position allows the light from the light source to enter the print medium directly;
the movable shutter is located at the opening position in the first mode and at the shielding position in the second mode; and
the current cutoff element is shielded from the light source by the movable shutter when the movable shutter is at the opening position and is not shielded from the light source by the movable shutter when the movable shutter is at the shielding position.

11. The drying device according to claim 1, further comprising a gas flow generator which generates a gas flow from the light source toward the print medium.

12. The drying device according to claim 1, wherein a thermostat is used as the current cutoff element.

13. A printing apparatus comprising:
a transport unit which is configured to transport a print medium;
a printing unit which is configured to perform printing on the print medium being transported; and
the drying device according to claim 1 which is provided downstream from the printing unit along a transportation path of the print medium.

14. The printing apparatus according to claim 13, wherein
the light shield includes a movable shutter configured to move between a shielding position where the movable shutter shields light from the light source toward the print medium and an opening position where the movable shutter having retreated from the shielding position allows the light from the light source to enter the print medium directly.
